(19) United States
(12) Patent Application Publication
(10) Pub. No.: US 2005/0000641 A1
(43) Pub. Date: Jan. 6, 2005

(54) Method for laser welding plastic parts

(76) Inventors: Siegfried Hartmann, Ibbenbueren (DE); Egon Wurr, Rheine (DE); E.K. Wolff, Herdecke (DE); U. Glotzbach, Witten (DE)

Correspondence Address: Karl F Milde Jr;Milde & Hoffberg, Suite 460, 10 Bank Street, White Plains, NY, 10606, US

(21) Appl. No.: 10/491,063

(22) PCT Filed: Sep. 28, 2002
(86) PCT No.: PCT/EP02/10922

(30) Foreign Application Priority Data
Sep. 29, 2001 (EP) 01123507.4

(51) Int. Cl. B32B 31/00

(52) U.S. Cl. 156/272.8

(57) ABSTRACT

The invention relates to a method for laser welding, wherein n plastic parts (1.1, . . . , 1.n) are pressed against each other, respectively forming a boundary layer (2.1, . . . , 2.n-1). An energy-converting medium (4.1, . . . , 4.n-1) is incorporated into each boundary layer (2.1, . . . , 2.n-1) and absorbs the light energy of at least one of several laser beams used (11.1, . . . , 11.m). Irradiation of the boundary layers (2.1, . . . , 2.n-1) by means of the laser beams (11.1, . . . , 11.m) respectively results in a partial melt, whereupon a welding seam point (3.1, . . . , 3.n-1) forms an inner link between the plastic parts (1.1., . . . , 1.n) upon cooling. The energy-converting media can be chosen according to type, coating thickness, etc., so that a melt is obtained upon simultaneous irradiation with two or more laser beams. In another embodiment of the inventive method, a laser beam (11.1) having a wavelength of λ₁ is used, the light thereof being partially absorbed in a first boundary layer (2.1) by a partially permeable energy-converting medium. The light energy which remains after the first passage through the first energy-converting medium (4.1) of the same laser beam (11.1) is then absorbed in the second boundary layer (2.2) by a second energy-converting medium (4.2).

The invention relates to a method for laser welding plastic parts.

It is known from U.S. Pat. No. 6,207,925 B1 to weld together plastic parts by means of light energy emitted from a laser. For this, a first plastic part is selected that is light permeable to laser light at a specific wavelength. Also, a second part is inserted that is made of a plastic that predominantly absorbs the light energy from the laser beam, leading to local heating and eventual partial melting of the absorbing plastic. This melted mass binds with the surface layers of the first, light permeable plastic part, and thus leads to a fused connection of the plastic parts.

It has been shown, however, that the partial melting occurs predominantly in a boundary zone of the light-energy-absorbing plastic parts, and partial melting of the light permeable piece occurs only at the surface, so that no homogeneous connection of the pieces occurs. When viewed as a cross-section through the weld seam, it is shaped as a lens, whereby the largest portion of this lens is embedded within the cross-section of the absorbing plastic.

Unfavorable force transfer from the light permeable to the light-absorbing plastic part arises because of the nonsymmetrical position of the weld seam, and strong diffractive effects arise at the edge of the weld seam, so that the strength of such a weld seam is inadequate in many cases.

A welding method is known from PCT/WO 00/20157 in which a medium that absorbs the energy of a laser beam and converts into heat energy is placed at a boundary layer between a first plastic part and a second plastic part resting upon it, whereby the first plastic part is light permeable to the laser beam.

By including the energy conversion medium in the boundary layer instead of mixing it into one of the matching parts, a homogeneously strong partial melting of the surface layers of both matching parts is achieved. The plane of symmetry of a weld seam so designed essentially extends in the boundary layer between the adjacent matching parts.

However, welding may only be undertaken if a plastic part facing outward is penetrated and the light energy is absorbed in the adjacent boundary layer. Several layers cannot be bound in one pass.

It is thus the principal object of the invention to provide a method for laser welding of more than two plastic parts by means of which a welding process may be performed in several boundary layers in adjacent plastic parts.

This object is achieved by a method for laser penetration welding of more than two plastic parts with the process steps in Patent Claim 1.

The particular advantage of this method is that more than two plastic parts may be joined together in a single welding step; position-oriented welding is no longer required. The basic concept is that each boundary layer to be welded is assigned at least one laser beam with a specific wavelength and a specific, absorbing energy-converting medium. The permeability of the plastic parts is so selected that each laser beam passes through one or more layers of plastic parts unhindered until it reaches the boundary layer that includes an energy-converting medium that absorbs the light of its specific wavelength. It is particularly advantageous if the weld seams extend independently of one another; they need not cover the same area.

This is why the plastic layers are light permeable to laser light. The makeup of the lowest layer has no influence on the effects of the method according to the invention. An energy-converting medium may be partially or completely mounted in each of the boundary surfaces thus arising between two matching parts. So, a laser with a specific wavelength and an energy-converting medium absorbing at that wavelength is selected for each boundary layer. The wavelengths are so selected that an energy conversion results in only one of the boundary layers, and so that the laser beam passes through the other layers with only minor energy absorption (less than 10% of the emitted energy). In particular it is thus possible to combine plastic fabric or film in one step with seams in different layers extending in varying directions.

It is also possible to provide an additional boundary layer in which welding occurs only when at least two laser beams strike an energy-converting medium that absorbs the light from both lasers simultaneously. For this, the energy-converting medium is selected based on absorption coefficient and layer thickness so that the energy of a single laser beam is insufficient to achieve partial melting of the matching parts in the area of the boundary layer. Partial melting only occurs when an additional laser beam is aimed at this energy-converting medium.

For example, a total of four plastic parts may be welded together in this manner using the light from two lasers with different wavelengths, namely a first boundary layer with a first laser, a second boundary layer with a second laser, and a third boundary layer by using both lasers together.

In a further advantageous embodiment of the method based on the invention, the objective is achieved by means of the steps of Patent Claim 3.

With this version of the invention, at least three plastic parts may be bound together in that the light energy of a laser beam strikes a first boundary layer where the light energy is only partially absorbed, and the laser beam may pass through to the second boundary layer with reduced intensity, where the remaining energy is absorbed and converted into energy. Depending on the degree of absorption in the boundary layers, the output power of the laser, the melting point of the plastic, etc., partial absorption may result in three or more layers. The significant thing is that the energy absorbed in each layer is adequate for partial melting of the matching part.

A first absorption degree A1 of 0.3 to 0.7 and a second absorption degree A2 of 0.3 to 1.0 have shown to be particularly suitable when welding three plastic parts.

Based on the invention, such energy-converting media that possess an absorption degree of greater than or equal to 10% of the emitted light energy are considered to be absorbent.

Such energy-converting media that possess an absorption degree of less than 10% of the emitted light energy are considered to be light permeable.

Insertion of the energy-converting medium into the boundary layer may be performed using any known method such as subsequent application, printing, flocking, scattering, or spraying. It is particularly possible here only to insert the energy-converting medium into those places in the boundary layer where the desired weld seam lies. A full-surface application of energy-converting medium in the area of the boundary layer is possible, but not necessary.

The energy-converting medium is preferably applied to the surface of the light permeable plastic part, and the second plastic part is pressed onto it. Boundary surface reflections are largely avoided by the application on the rear side of the penetrated first plastic part, and the emitted laser energy passes to the energy-converting medium with practically no loss.

In a large number of application possibilities, carbon is a suitable energy-converting medium since it absorbs all wavelengths of light, thus allowing the use of lower-cost lasers. When welding multiple layers, it may be inserted into the lowest layer, i.e., the last one to be penetrated. Also, carbon in the form of soot is a low-cost, widely used filler material in the plastics industry. Soot is also suitable for inclusion into solvent-based paints or polymer solutions, and then for application onto one of the matching parts by means of printing etc.

The energy-converting medium may be placed between the plastic parts in the form of a light-absorbing welding film. This can eliminate of the necessity for a pressing process or similar. The welding film is introduced to the site and at the moment of the weld. It is also possible to combine plastic parts not compatible with each other using the welding film as an adhesive.

In another advantageous embodiment of the method according to the invention, the welding film consists of a plastic that possesses a lower melting point in contrast to the matching parts, and into which additional additives are included besides the energy-converting medium. This achieves the result that a total melting of the welding film occurs when it is irradiated with laser energy, and the additives are contained in the molten mass. When the heat is transferred to the matching parts and they melt, the welding bath with the additives are distributed about the surface in the area of the weld seam position so that intentional inclusion of additives into the weld seam is possible.

For example, cross-linking agents activated by ultra-violet light may be included so that additional strengthening of the weld seam is achieved by subsequent irradiation with ultra-violet light.

Also, additives may be provided that reflect ultra-violet light so that the progression and the quality of a weld seam are visible under so-called black light.

It is further advantageous that the energy absorption coefficients, the layer thickness of the energy-converting medium, the wavelength, the energy, and the duration of the laser used may determine the heat required to be added to the area of the weld seam. In such manner, an amount of heat may be created that is adequate for partial melting and homogeneous binding of the matching parts, but that does not lead to overheating the plastics until they are locally damaged or destroyed.

It is also possible using the method according to the invention to create a seal seam. For this, those energy-converting media are chosen that are absorptive only in a very narrow band for light energy with a specific wavelength. Possessing only the knowledge of the special wavelength and the other parameters adapted to each boundary layer, it is thus possible to weld a container and then open the weld seam without destroying it.

This function may be reinforced in the manner of a key in that lasers with several wavelengths must be used simultaneously on the energy-converting medium in order to produce local partial melting. Upon such an intentional opening of only the seal bead, the welded plastic parts retain their shape, but unauthorized attempts to open by means of uncontrolled external heat transfer lead to a complete softening and thus to visible damage to the plastic parts.

The invention is explained in the following with reference to the Illustrations, which show:

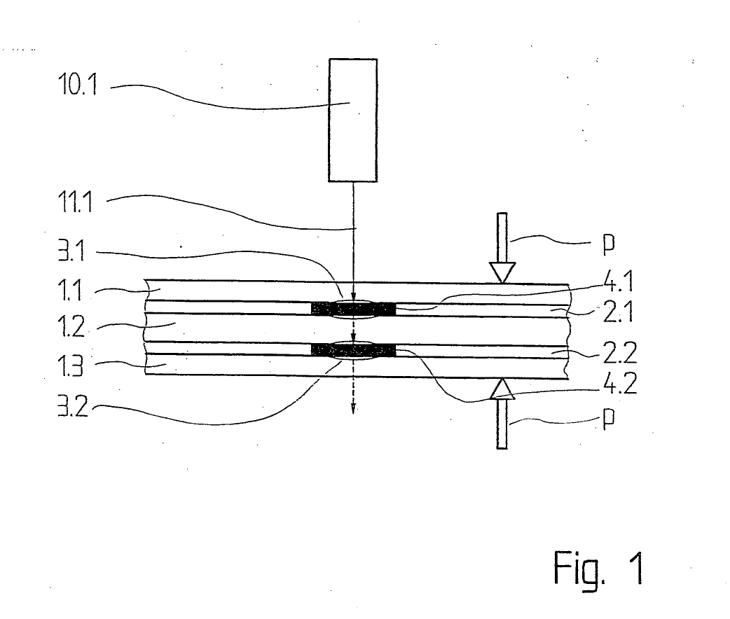

FIG. 1 welding of three plastic parts in schematic view;

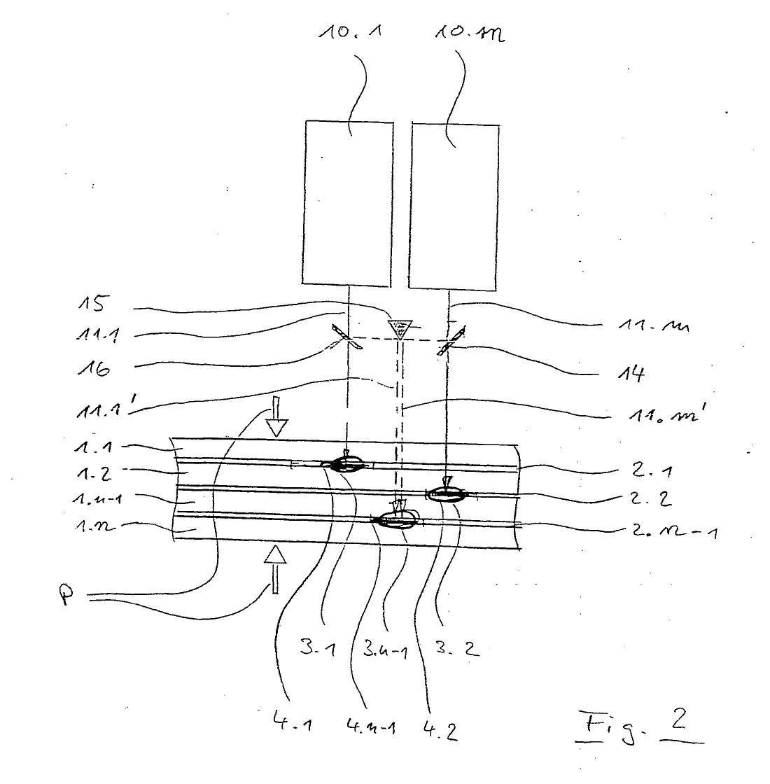

FIG. 2 welding of four plastic parts in schematic view;

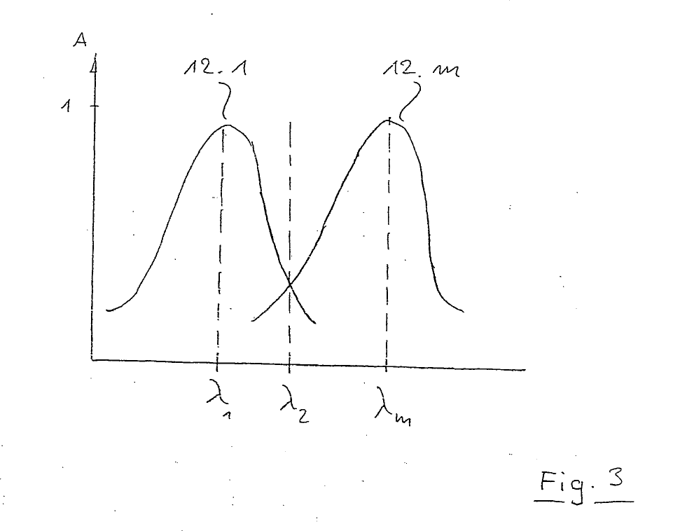

FIG. 3 light absorption of two energy-converting media in a diagram based on wavelength; and

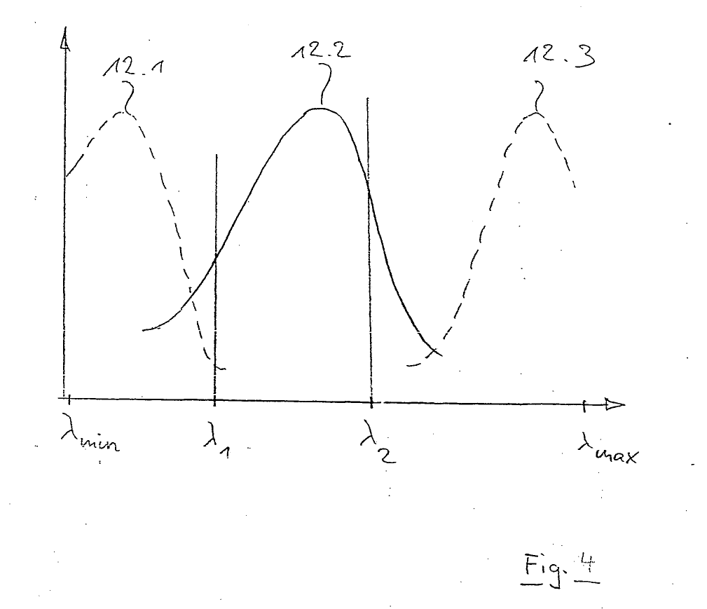

FIG. 4 light absorption with a seal bead in a diagram based on wavelength.

FIG. 1 shows three stacked plastic parts 1.1, 1.2, and 1.3 into whose boundary layer 2.1, 2.2 an energy-converting medium 4.1, 4.2 has been partially inserted. The artist-rendered dimensional relationships are not to scale, and serve merely for elucidation.

The energy-converting medium 4.1, 4.2 is usually inserted with a thickness of about 1-100 μm. Also, instead of the plate-shaped plastic parts 1.1-1.3 shown, there are such that are welded using the method based on the invention that are shaped as necessary, but include plate surfaces on the side facing the boundary layer 2.1, 2.2 so that they come into contact with each matching part in the area of the intended weld seam 3.1.

The thickness of the upper plastic parts 1.1 and 1.2 to be penetrated is of suitable permeability to a laser beam 11.1 emitted from a laser 10.1, and may be determined according to need as long as the light damping or absorption within the plastic parts 1.1 and 1.2 is not so strong that partial melting of the boundary layers 2.1, 2.2 is no longer achieved. The thickness of the non-penetrated lower plastic part 1.3 is adjustable as determined by the need.

The laser beam penetrates the plastic part 1.1, strikes energy-converting medium 4.1 included in the boundary layer 2.1 whereby a first component of the light energy is converted into heat energy. The energy-converting medium absorbs the light energy at an absorption degree of A1, but is partially light permeable, so that a component of the laser beam 11.1 passes through the energy-converting medium 4.1.

Based on the laws of thermodynamics, and with respect to environmental influences, e.g., by cooling, the amount of heat per time may be calculated that must be input to the boundary layer in order to cause partial melting of the plastic parts 1.1, 1.2 in the area of the boundary layer 2.1 but without causing complete melting, softening, or destruction of the plastic parts 1.1, 1.2.

The laser beam 11.1 reduced in intensity in the first boundary layer 2.1 by partial absorption passes through the middle plastic part 1.2 and strikes the second energy-converting medium 4.2 in the boundary layer 2.2. Here, the remaining energy of the laser beam 11.1 is completely absorbed, or at least to the extent that a second absorption degree of A2 reduces it to such a component that partial melting of plastic parts 1.2, 1.3 is also possible in the second boundary layer 2.2.

Along with the influence of the amount of heat to be induced by selection of absorption coefficients and layer thickness of each energy-converting medium 4.1, it is also possible to control the energy output from the laser, e.g., by means of controlling the pulse length and frequency. Also, intentional focusing or defocusing of the laser beam 11.1 may be performed.

A lens-shaped weld seam location 3.1 is formed by the welding step that becomes molten and then cools and hardens after termination of the irradiation. The plane of symmetry of the weld seam location 3.1 or its center of mass lies approximately within the boundary layer 2.1.

Further, the heat transfer from the energy-converting medium to the adjacent plastic parts, and thus the dissipation of the heat absorbed in the boundary layer 2.1 into the plastic parts can be influenced by the contact pressure of the matching parts and of the energy-converting medium lying between them. In FIGS. 1 and 2, the arrow designated with P represents the contact pressure. By means of high contact pressure P, the weld seam position 3.1 is pressed deeper into the plastic parts 1.1 and 1.2 so that the weld seam position 3.1 possesses an ellipsoidal cross-section with great height but low expansion. In contrast, a relatively low contact pressure P leads to the formation of a weld seam 3.1 with an ellipsoidal cross-section with low height but great width.

FIG. 2 shows the welding of a total of four plastic parts 1.1-1.n using two lasers 10.1, 10.m. A first laser beam 10.1 first passes by a mirror 15, e.g., a conventional half-silvered mirror or a mirror, and strikes a first energy converting medium 4.1 within a first boundary layer 2.1, by which it is absorbed. A first weld seam location 3.1 is created that binds the plastic parts 1.1 and 1.2 together.

An additional laser beam 11.m passes by a mirror 14, penetrates the first plastic part 10.1, the first boundary layer 2.1, and the second plastic part 10.2 without significant energy absorption, and is absorbed by a energy-converting medium 4.1 within the second boundary layer 2.2. a second weld seam location 3.2 is created that binds the plastic parts 10.2 and 10.3 together.

Next, the laser beams 11.1, 11.m are redirected via the mirrors 14, 16. Bundling of both beams 11.1, 11.m occurs via an optical device 15. The beams penetrate the first three plastic parts 1.1, 1.2, and 1.3 with the intermediary boundary layers 2.1, 2.2, and strike an additional energy-converting medium 4.n-1 within the boundary layer 2.n-1 that absorbs both beams 11.1 and 11.m. The absorbed energy of both beams 11.1 and 11.m together is adequate to create a third weld seam position 3.n-1; if, however, only one of the beams 11.1 or 11.m alone strikes the boundary layer 2.n-1, then heating results, but no partial melting.

FIG. 3 shows schematically the absorption factor A of the energy-converting medium at the wavelength λ. The curve 12.1 shows the absorption of the light of a first energy-converting medium 4.1; the curve 12.2 shows the absorption of the light of a second energy-converting medium 4.m. The lasers 11.1, 11.m are so selected that their wavelengths lie within the areas of greatest absorption λ₁ or λₘ.

For the area of overlap of curves 12.1 and 12.m, the following option is presented: an additional laser with a wavelength λ₂ can be provided. The energy converting medium with an absorption per 12.1 and 12.m that possess about half of their maximum absorption at a wavelength of λ₂ are mixed. Upon irradiation by a laser beam with light of wavelength λ₂, each energy-converting medium 4.1, 4.m absorbs a component of the energy. Together, this is adequate to cause local partial melting and welding, but a light beam of wavelength of λ₁ or λₘ would not.

It is thus possible to weld only the cross-points in a fabric when the weft yarn is coated with a first energy-converting medium, and the woof yarn with a second. In the overlap at the node points, both energy-converting media are adjacent, so that a laser beam with wavelength λ₂ can only cause a weld at those positions while it otherwise may shine over the surface of the fabric without causing partial melting. The fabric remains flexible because of the connections only at the node points.

If only one weld seam location is to be created, the use of a low-cost semiconductor laser to create the laser beam in the red or Near InfraRed (NIR) area at and from carbon, particularly in the form of soot, as a energy-converting medium in the boundary layer. In fact, a simple application of the energy-converting medium using crayons provided with black pigment such as is known under the trade name EDDING, with water-soluble dyes such as is known under the trade name PLAKA, or with commercial or China ink, may be performed. After drying of the carrier liquid, an adequately thick layer of pigments remains that is suitable as an energy-converting medium.

It must be mentioned that several state-of-the-art lasers may be used for the welding method according to the invention. There are many parameters available with the method according to the invention for welding single or multiple layers for the control of heat creation in the weld seam location:
Wavelength, pulse length, output, and effective duration of the laser used;
Degree of absorption with respect to the laser wavelength and layer thickness of the energy-converting medium; and
Thickness of the matching parts and their contact pressure.

These various parameters may be combined in so many ways that a seal seam with guaranteed function can be produced. Production of such a seal seam is explained using FIG. 4:

Two lasers are selected that emit light at wavelengths λ₁ and λ₂. There are no known lasers or other irradiation sources with a narrow spectrum for the spectral area between λ₁ and λ₂. An absorption degree of about 0.25 of the energy-converting medium per Curve 12.2 occurs at λ₁, and an absorption degree of 0.75 at λ₂. Partial melting of the seal area occurs upon simultaneous irradiation with lasers of wavelengths λ₁ and λ₂. Irradiation by only one of the lasers is inadequate to create enough heat in the boundary layer for the seal seam to be closed or opened.

Embedding of energy-converting medium into the matching plastic parts with an absorption in adjacent spectral areas per Curve 12.1 or 12.3 achieves complete melting, and thereby destruction, of the plastic parts when one attempts to open the seal layer using a non-specific irradiation source with a broad spectrum of from λₘᵢₙ to λₘₐₓ.

Closing and opening the seal seam therefore requires exact knowledge of the absorption and the layer thickness of the energy-converting medium, and of the suitable wavelength for the laser.

The lasers used in the method based on the invention may emit electromagnetic radiation in the visible, the infra-red, or the ultra-violet spectrum.

1. Method for laser-penetration welding of more than two plastic parts comprising the following steps:
providing m laser beams with different wavelengths λ₁, . . . , λₘ in a spectrum between a lower wavelength λₘᵢₙ and an upper wavelength λₘₐₓ;
contact pressing n plastic parts under formation of a boundary layer between each two adjacent plastic parts, wherein at least n-1 adjacent plastic parts are light permeable for at least one wavelength of a laser beam in the spectrum of from λₘᵢₙ to λₘₐₓ and wherein an exterior plastic part includes any degree of light permeability;
incorporating at least one energy-converting medium that absorbs the light energy of at least one of the laser beams in the spectrum from λₘ₀ to λₘ₁ into each boundary layer;
irradiating the boundary layers using the laser beams upon penetration of the plastic parts located above each boundary layer; and
partial melting of each plastic part in the area of each boundary layer, and allowing cooling under the formation of weld seam location as a homogeneous bond between the plastic parts.

2. Method as defined in claim 1, wherein an energy-converting medium is inserted into at least one of the boundary layers that absorbs different wavelengths λ₁, λₘ, and that wherein the plastic parts adjacent to the boundary layer are partially melted by irradiation of the boundary layer by at least two laser beams with wavelengths λ₁, λₘ, whereby at least one of (1) the layer thickness, (2) the absorption coefficient of the energy-converting medium, (3) the strength, and (4) effective duration of the energy from the laser beams are so selected that heating of the plastic parts to the point of partial melting and creation of a weld seam location results only upon simultaneous irradiation with at least two laser beams.

3. Method for laser-penetration welding of more than two plastic parts comprising the following steps:
providing by at least one laser beam with a wavelength λ₁;
contact pressing at least three plastic parts upon creation of a boundary layer between each pair of adjacent plastic parts, wherein at least two adjacent plastic parts are light permeable for the laser, and wherein a lowermost exterior plastic part includes any degree of light permeability;
incorporating a first partially-light permeable energy-converting medium that partially absorbs the light energy of at least one laser beam with a degree of absorption of A1 into the first boundary layer and inserting a second energy-converting medium into the second boundary layer that absorbs the energy remaining after penetration through the first energy-converting medium by that same laser beam with a second degree of absorption A2;
irradiating the boundary layers using the laser beam for penetration of the plastic parts located above each boundary layer, and via partial conversion of the light energy of the laser into heat in the first and second boundary layers; and
allowing partial melting of each plastic part in the area of each boundary layer, and allowing cooling under formation of a weld seam location as a homogeneous bond between the plastic parts.

4. Method as defined in claim 3, wherein three plastic parts are bonded together, and the first degree of absorption A1 is from 0.3 to 0.7, and second degree of absorption A2 is from 0.3 to 1.0.

5. Method as defined in claim 1, wherein the energy-converting medium is deposited between the plastic parts in the form of a light-absorbing weld film.

6. Method as defined in claim 1, wherein the weld film contains additives as interlaced in ultraviolet light or which are visible under ultraviolet light.

7. Method as defined in claim 1, wherein the energy-converting medium is applied to the rear side of a penetrated plastic part.

8. Method as defined in claim 1, wherein carbon is selected as the energy-converting medium.

9. Method as defined in claim 1, wherein the penetration depth of the weld seam location is varied in the plastic parts by means of contact pressure P.
